(19) United States
(12) Patent Application Publication
(10) Pub. No.: US 2010/0212840 A1
(43) Pub. Date: Aug. 26, 2010

(54) Cut-Resistant Strip Door

(76) Inventor: Fred Jevaney, Elmhurst, IL (US)

Correspondence Address: BRINKS HOFER GILSON & LIONE, P.O. BOX 10395, CHICAGO, IL, 60610, US

(21) Appl. No.: 12/389,956

(22) Filed: Feb. 20, 2009

(51) Int. Cl. E06B 9/00

(52) U.S. Cl. 160/127; 160/236

(57) ABSTRACT

A cut-resistant strip door is provided. The strip includes one or more strips that include a component that makes the strip resistant to accidental or intentional tearing or cutting. In one embodiment, the strips include a metal cable that is attached to the surface or longitudinal edge of the strips.

### FIELD OF THE INVENTION

The present invention relates to strip doors that are often used in doorways or openings to keep warm or cool air inside enclosed areas.

### BACKGROUND OF THE INVENTION

Strip doors are used to separate areas of different temperature. For example, a strip door may be used in a doorway to a large walk-in cooler or in a doorway to a refrigerated delivery truck. Strip doors employ a series of plastic strips that hang vertically from a support structure mounted above or in an opening. Since the strips are flexible, they bend as traffic passes through them. A general description of one strip door is provided, for example, in U.S. Pat. No. 4,086,950 to Power, the disclosure of which is incorporated by reference herein in its entirety. Another strip door is described in U.S. Pat. No. 4,289,190 to Catan, the disclosure of which is also incorporated by reference herein.

The strips that make up a strip door are subject to being broken or cut during use. Such damage may be the result of ordinary wear and tear. More often, it is the result of intentional cutting by workers that must walk through the strips several times a day. The strips that make up a strip door can be annoying because they are always in the way and they are prone to hitting workers in the face and body as they pass through them. Annoyance and frustration leads some workers to cut the strips with box cutters or the like. With the strips out of the way they are no longer a problem. Such cutting, however, defeats the purpose of the strip doors (to separate areas of different temperature) and results in costly repairs to replace the damaged strips. Thus, it is desirable to have a strip door that is resistant to accidental or intentional cutting.

### SUMMARY OF THE INVENTION

A strip door is provided that includes a series of flexible strips. At least one of the strips has a longitudinal direction, two longitudinal edges and two faces. The strip also includes a cut-resistant component that is generally disposed in the longitudinal direction of the strip.

### BRIEF DESCRIPTION OF THE DRAWINGS

FIG. 1. shows an example of a prior art strip door.

FIG. 2 shows a cross-section of one embodiment of a strip that may be used in the present invention.

FIG. 3 shows a cross-section of another embodiment of a strip that may be used in the present invention.

FIG. 4 shows a cross-section of another embodiment of a strip that may be used in the present invention.

FIG. 5 shows a cross-section of another embodiment of a strip that may be used in the present invention.

FIG. 6 shows a cross-section of another embodiment of a strip that may be used in the present invention.

FIG. 7 shows a cross-section of another embodiment of a strip that may be used in the present invention.

FIG. 8 shows a cross-section of another embodiment of a strip that may be used in the present invention.

FIG. 9 shows a cross-section of another embodiment of a strip that may be used in the present invention.

### DETAILED DESCRIPTION OF THE DRAWINGS

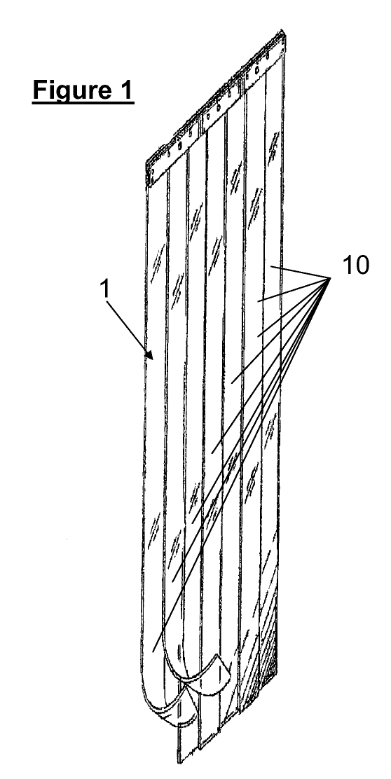

An example of a strip door is shown in FIG. 1. The strip door 1 includes a series of flexible strips 10 that hang vertically from a support structure mounted above or in a doorway. The strips 10 have two short edges, two long edges, and two faces. The long edges define a longitudinal direction. The strips are preferably transparent, relatively flexible, stable and durable and not readily subject to cracking from cold or abrasion. The strips may be made of plastic such as vinyl, polyethylene, polyvinyl chloride, polyethylene vinyl, or the like. The strips may be provided in thicknesses from a relatively thin gauge up to perhaps 50 gauge material.

The strips 10 may be attached to a doorway using any acceptable means of attachment. For example, the strips may be secured to a doorway using a series of nuts, bolts, and mounting brackets as described, for example, in U.S. Pat. No. 4,289,190 to Catan and U.S. Pat. No. 4,086,950 to Power.

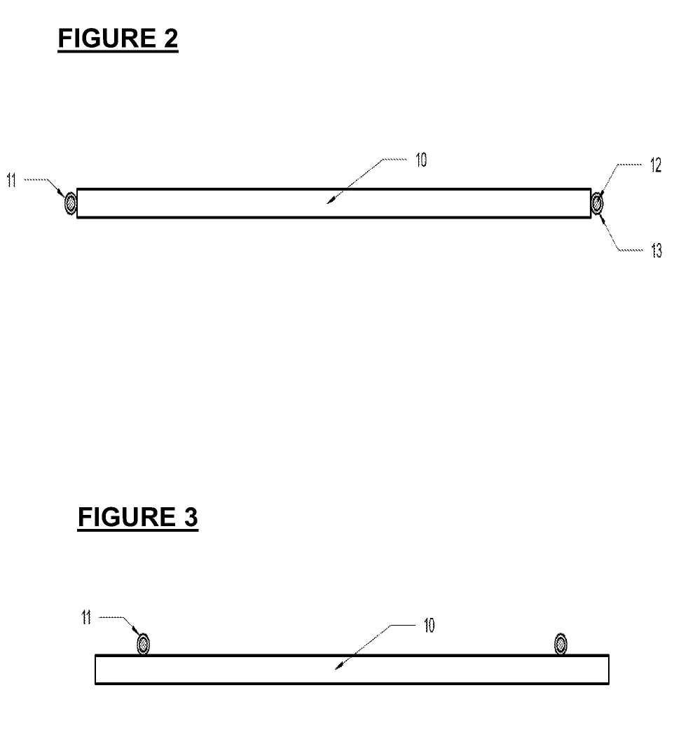

The strip doors of the present invention include a cut-resistant component that inhibits lateral cutting or tearing of the individual strips. In a preferred embodiment, for example as shown in FIG. 2, one or more of the strips 10 include a metal cable 11 that is attached to a longitudinal edge of strip. A preferred cable is ¼ inch woven stainless steel cable 12 that includes a polyvinyl chloride (PVC) covering 13. The cable may be any thickness that is sufficient to inhibit cutting. It should be understood, however, that the thickness of the cable may be tailored to the particular application and the thickness of the cable does not limit the scope of the present invention.

The cut-resistant component may be attached to the strip using any acceptable method that securely attaches the cut-resistant component to the strip or includes the cut-resistant component within the strip.

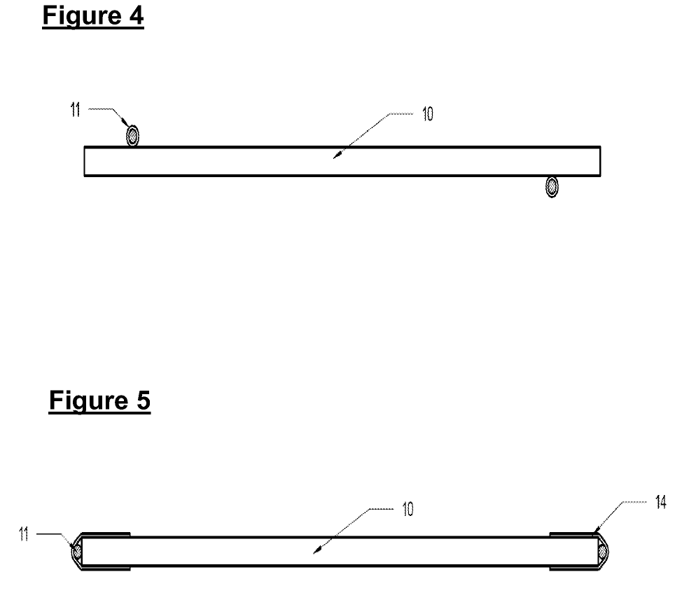

The cable 11 may be attached to the strip 10 using any acceptable means. In a preferred embodiment, the PVC-coated cable 11 is attached to the longitudinal edge (FIG. 2) or surface (FIGS. 3 and 4) of the strip 10 by fusing the PVC coating on cable 11 to the strip 10 using a rotary heat welder. Alternatively, the PVC-coated cable 11 may be fused to the strip 10 using hot melt or ultrasonic technology.

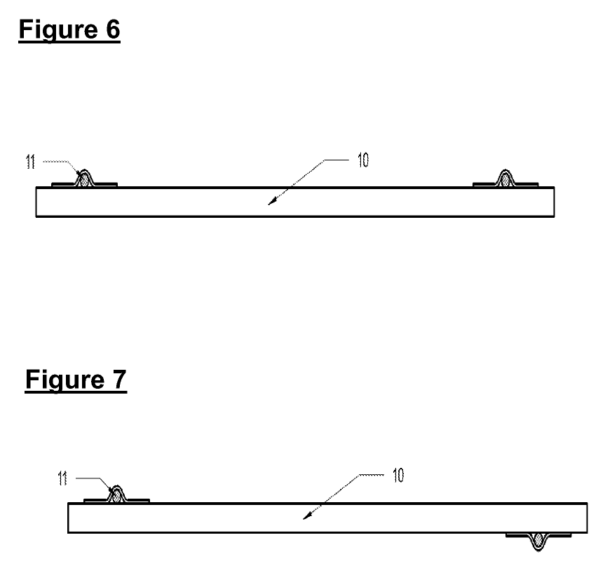

An alternative embodiment is shown in FIG. 5, which depicts another method of attaching the cable 11 to the strip 10. The cable 11 may be attached to the strip 10 by wrapping a thin sheet of PVC around the cable and the longitudinal edge of the strip 10. The assembly is then fused together using a rotary heat welder. As a result, the sheet of PVC bonds with the strip 10 and secures the cable 11 in place. A preferred PVC sheet for use in this embodiment is approximately 0.06 to 0.160 inches thick. The same technique may be used to attach the cable 11 to one or more surfaces (i.e. faces) of the strip 10 with a thin sheet of PVC. This is shown in FIGS. 6 and 7.

Alternatively, the cut-resistant component may be glued to the strip 10 using acrylic or any other acceptable adhesive that securely attaches the cut-resistant component to the strip 10.

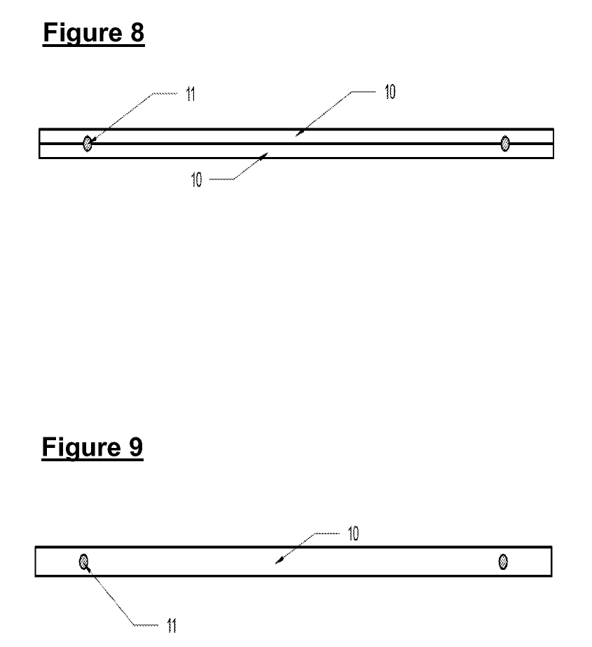

The cut-resistant component also may be provided by incorporating the cut-resistant component into the strip 10 during the manufacturing process. For example, as shown in FIG. 8, the cut-resistant component may be sandwiched between two sheets. Alternatively, as shown in FIG. 9, the cut-resistant component may be integrally molded within the strip when the strip is extruded, rolled, molded, or otherwise formed from the raw materials.

As discussed above, the cut-resistant component preferably is a woven metal cable that is coated with PVC. Alternatively, the cut-resistant component may be a woven metal cable that includes a covering made of something other than PVC and the metal may be an acceptable metal or wire other than stainless steel cable. Further, the cut-resistant component may be any other component that provides substantial cut-resistance when placed longitudinally on or within a strip 10.

The cut-resistant component may be attached to any portion of the strip. Preferably, as shown in FIG. 2, the cut-resistant component is attached to one or both of the longitudinal edges of the strip. Alternatively, the cut-resistant component may be applied to the faces of the strip, as shown in FIGS. 3 and 4. If applied to the face of the strip, the cut-resistant component may be placed near the longitudinal edges, in the middle of the strip or anywhere in between, so long as the location of the cut-resistant component inhibits lateral cutting or tearing of the strip.

It is intended that the foregoing detailed description be regarded as illustrative rather than limiting, and that it be understood that it is the following claims, including all equivalents, that are intended to define the spirit and scope of this invention.

1. A strip door comprising a series of flexible strips, wherein one of the strips has a longitudinal direction, two longitudinal edges and two faces and the strip further comprises a cut-resistant component that is generally disposed in the longitudinal direction of the strip.

2. The strip door of claim 1, wherein the cut-resistant component is a metal cable.

3. The strip door of claim 1, wherein the cut-resistant component is attached to the exterior of the strip.

4. The strip door of claim 1, wherein the cut-resistant component is inside the strip.

5. The strip door of claim 2, wherein the metal cable includes a plastic coating.

6. The strip door of claim 5, wherein the metal cable is attached to the strip by fusing the plastic coating to the strip.

7. The strip door of claim 1, wherein the cut-resistant component is attached to a longitudinal edge of the strip.

8. The strip door of claim 1, wherein the cut-resistant component is attached to each of two longitudinal edges of the strip.

9. The strip door of claim 1, wherein each strip includes a cut-resistant component.

10. The strip door of claim 1, wherein the cut-resistant component is attached to one or more faces of the strip.
